(19) United States
(12) Patent Application Publication
(10) Pub. No.: US 2011/0085848 A1
(43) Pub. Date: Apr. 14, 2011

(54) STABILIZER LINK MOUNTING UNIT FOR SHOCK ABSORBER

(75) Inventor: Bo Min KIM, Seoul (KR)

(73) Assignee: Hyundai Motor Company, Seoul (KR)

(21) Appl. No.: 12/773,467

(22) Filed: May 4, 2010

(30) Foreign Application Priority Data
Oct. 8, 2009 (KR) 10-2009-0095826

(51) Int. Cl. F16B 7/04

(52) U.S. Cl. 403/187

(57) ABSTRACT

A stabilizer link mounting unit for a shock absorber for mounting a stabilizer link connected to a stabilizer bar to the shock absorber may include a mounting bracket formed as one piece and removably engaged on an exterior circumference of the shock absorber, wherein the mounting bracket is connected to the stabilizer link.

### CROSS-REFERENCE TO RELATED APPLICATION

The present application claims priority to Korean Patent Application No. 10-2009-0095826 filed on Oct. 8, 2009, the entire contents of which are incorporated herein for all purposes by this reference.

### BACKGROUND OF THE INVENTION

1. Field of the Invention

The present invention relates to a stabilizer link mounting unit for a shock absorber. More particularly, the present invention relates to a stabilizer link mounting unit for a shock absorber that is formed as one piece in order to mount a stabilizer link connecting a shock absorber with a stabilizer bar, and is removably mounted on the shock absorber.

2. Description of Related Art

Generally, a suspension system of a vehicle is an important system for enhancing ride comfort and driving stability. Such a suspension system stably supports a vehicle body from wheels and reduces vibration delivered from the wheels.

The suspension system effectively reduces irregular vibration generated from a road when a vehicle runs so as to provide ride comfort to passengers, controls shake of the vehicle body generated by driving action and curves of the road so as to provide driving convenience, and maintains vertical load applied from the road so as to secure stability when the vehicle turns or brakes.

Recently, various types of suspension systems have been developed and applied to vehicles. One example of suspension systems is a suspension system of a McPherson strut type, and it will be described briefly,

As shown in FIG. 4, a knuckle 103 rotatably supporting a wheel 101 has a lower end connected to a vehicle body 109 by interposing a lower arm 105 therebetween. An upper portion of the knuckle 103 is connected to a shock absorber 110, and a strut 107 of the shock absorber 110 has an upper end connected to the vehicle body 109.

A lower spring seat 111 is slidably mounted at a lower portion of the strut 107, and supports a coil spring 115 together with an upper spring seat 113 mounted at an upper portion of the strut 107.

Also, an insulator unit 121 is interposed between an upper end of the strut 107 and a mounting portion of the vehicle body 109.

Herein, a stabilizer bar 117 is connected to one side of the shock absorber 110 via a stabilizer link 119.

One end of the stabilizer link 119 is connected to the stabilizer bar 117 and the other end of the stabilizer link 119 is connected to a stabilizer link mounting unit 120 mounted on the shock absorber 110.

A conventional stabilizer link mounting unit 120, as shown in FIG. 5, includes a link bracket 122 of a plate shape, and is fixedly mounted on an exterior circumference of the shock absorber 110 by welding.

However, since the conventional stabilizer link mounting unit 120 is welded on the exterior circumference of the shock absorber 110, it is impossible to change a mounting position thereof. Therefore, the link bracket 122 may be interfered with by other components, and the layout DOF of the shock absorber 110 may be deteriorated when the shock absorber 110 is mounted.

Meanwhile, in order to prevent interference between the link bracket 122 and other components, the link bracket 122 must be mounted on the shock absorber 110 at a position where the link bracket 122 is not interfered with by other components. Therefore, it is hard to mount the link bracket 122 on the shock absorber 110.

In addition, since the link bracket 121 is welded on the shock absorber 110, the shock absorber 110 may be damaged by heat occurring when welding is performed. Therefore, performance of the shock absorber 110 may be deteriorated or the shock absorber 110 may be out of order.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a stabilizer link mounting unit for a shock absorber having advantages of facilitating mounting processes, preventing interference with other components, and improving layout DOF as a consequence that the stabilizer link mounting unit is formed as one piece in order to mount a stabilizer link connecting a shock absorber with a stabilizer bar, and is removably mounted on the shock absorber.

In an aspect of the present invention, the stabilizer link mounting unit for a shock absorber for mounting a stabilizer link connected to a stabilizer bar to the shock absorber includes a mounting bracket formed as one piece and removably engaged on an exterior circumference of the shock absorber, wherein the mounting bracket is connected to the stabilizer link.

The mounting bracket may includes a body portion bent as a cylindrical shape and removably wrapping the exterior circumference of the shock absorber therein, mounting ends formed respectively at both ends of the body portion, and releasably fixing the body portion onto the shock absorber by a first fixing member, and a stabilizer link mounting portion formed by cutting a portion of an exterior circumference of the body portion and bending the portion outwards so as to be protruded radially from the body portion with a predetermined length, and connected to the stabilizer link by a second fixing member.

The mounting ends may be formed by bending distal end portions of the body portion so as to protrude outwards from the body portion with a predetermined length.

The mounting ends may be provided with a first hole at a middle portion thereof and fastened by the first fixing member, wherein the fixing member includes a bolt inserted in the first hole, and wherein the mounting bracket further includes a first reinforcing member reinforcing the mounting ends.

The first reinforcing member may be fixed to an external surface of the mounting ends with a predetermined thickness, wherein the first reinforcing member is fixed to an external surface of the body portion.

The first reinforcing member may be provided with a second hole at a middle portion thereof and the first reinforcing member and the mounting ends are fastened each other by the first fixing member through the first hole and the second hole respectively.

The stabilizer link mounting portion may be provided with a third hole at a middle portion thereof, and the stabilizer link is mounted to the stabilizer link mounting portion through the third hole by the second fixing member, wherein the second fixing member includes a bolt inserted in the third hole.

The mounting bracket may further include a second reinforcing member reinforcing the stabilizer link mounting portion, wherein the second reinforcing member includes a bonding portion mounted in a state of being contacted to a surface of the stabilizer link mounting portion and fixed thereto to be integrally formed with the body portion, wherein the bonding portion includes a fourth hole, and a supporting portion extending from both distal ends of the bending portion to face each other with a predetermined distance therebetween, mounted along an exterior circumference of the body portion, and supporting the bonding portion.

Supporting portion has an end portion contacted and fixed to the exterior circumference of the body portion, and the end portion is formed round along the exterior circumference of the body portion.

The stabilizer link mounting portion and the bonding portion may be mounted to the stabilizer link by the second fixing member through the third hole and the fourth hole respectively.

Each supporting portion may have an end portion contacted and fixed to the exterior circumference of the body portion, and the end portion is round.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view showing an exemplary stabilizer link mounting unit for a shock absorber according to the present invention which is mounted on the shock absorber.

FIG. 2 is a perspective view showing an exemplary stabilizer link mounting unit for a shock absorber according to the present invention.

FIG. 3 is a top plan view showing an exemplary stabilizer link mounting unit for a shock absorber according to the present invention.

FIG. 4 is a schematic diagram showing a general suspension system of a McPherson strut type.

FIG. 5 is an enlarged view of “A” in FIG. 4, which shows a conventional stabilizer link mounting unit for a shock absorber mounted on the shock absorber.

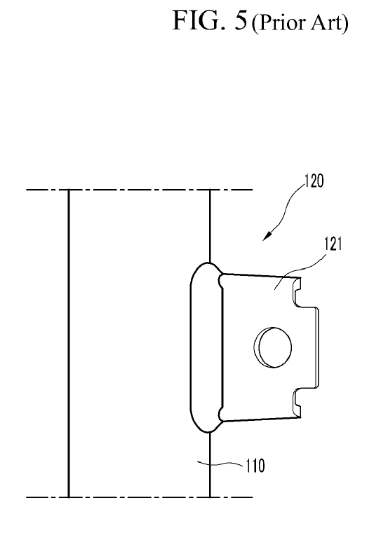

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment described in this specification and drawings is just a preferable exemplary embodiment, and it does not represent entire technical spirit of the present invention. Thus, it is to be understood that there may be various types of equivalents and variations at the filing date of this application.

In addition, in order to explain constituent elements of an exemplary embodiment of the present invention, the same constituent elements will be denoted by the same reference numerals in this specification.

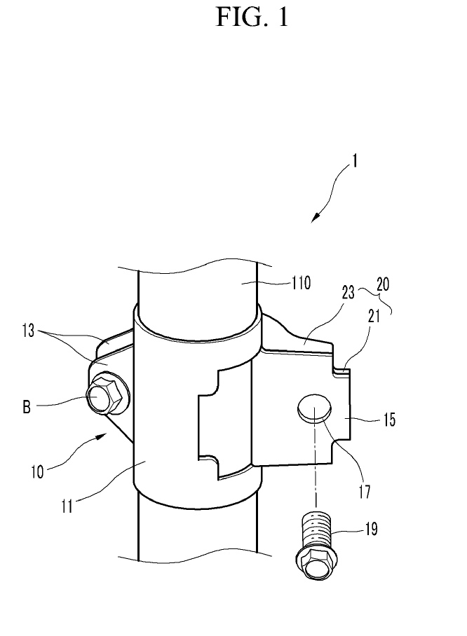

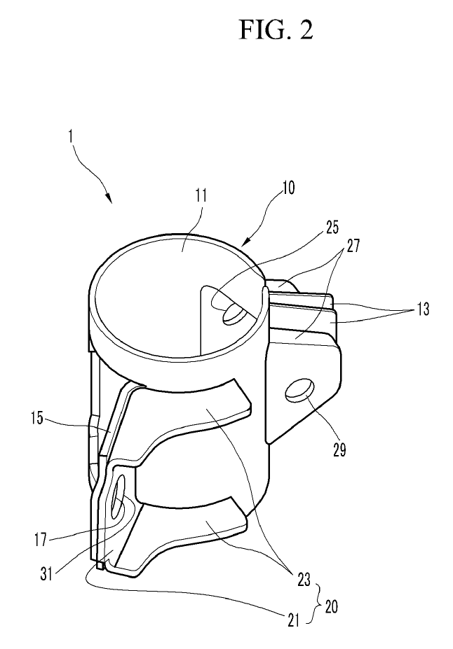

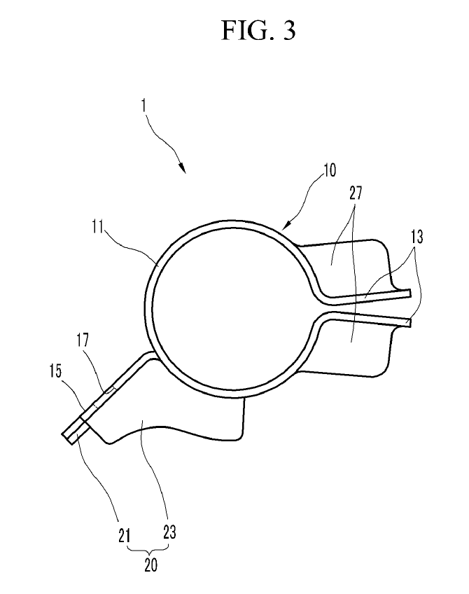

FIG. 1 is a perspective view showing a stabilizer link mounting unit for a shock absorber according to an exemplary embodiment of the present invention which is mounted on the shock absorber, FIG. 2 is a perspective view showing a stabilizer link mounting unit for a shock absorber according to an exemplary embodiment of the present invention, and FIG. 3 is a top plan view showing a stabilizer link mounting unit for a shock absorber according to an exemplary embodiment of the present invention.

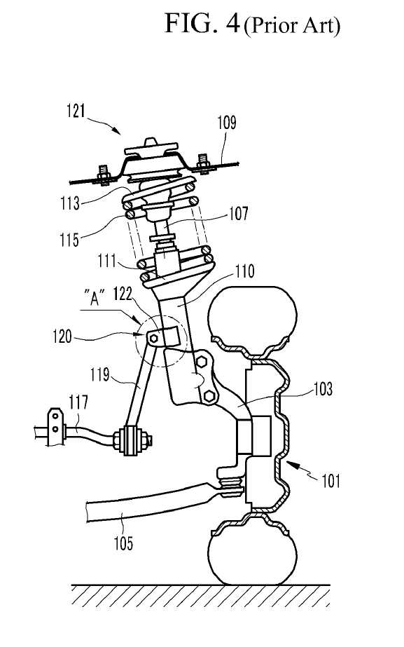

Referring to the drawings, a stabilizer link mounting unit 1 for a shock absorber according to an exemplary embodiment of the present invention is formed as one piece in order to mount a stabilizer link 119 (referring to FIG. 4) that connects a shock absorber 110 (referring to FIG. 4) with a stabilizer bar 117 (referring to FIG. 4), and is removably mounted on an exterior circumference of the shock absorber 110. Accordingly, mounting processes of the stabilizer link mounting unit 1 may be facilitated, and the stabilizer link mounting unit can be mounted at a position where it is not interfered with by other components. Thus, layout DOF of the shock absorber 110 may be improved.

For this purpose, the stabilizer link mounting unit 1 for a shock absorber according to the exemplary embodiment of the present invention, as shown in FIG. 1 to FIG. 3, includes a mounting bracket 10 that is removably engaged on the exterior circumference of the shock absorber 110 and is connected to the stabilizer link 119.

The mounting bracket 10, as shown in FIG. 2, includes a body portion 11, a mounting end 13, and a stabilizer link mounting portion 15, and each component will be described in detail.

The body portion 11 is formed in a cylindrical shape in order to surround the exterior circumference of the shock absorber 110 in a state in which the shock absorber 110 is inserted therein. For this purpose, the body portion 11 is formed by bending one metal plate to have a cylindrical shape and forming mounting ends 13 respectively at both ends thereof.

The mounting ends 13 are formed respectively at both ends of the body portion 11 and respectively have holes 25. Therefore, after the body portion 11 is positioned at a target position of the shock absorber 110, a bolt B is inserted in the hole 25 formed at the mounting end 13 and a nut (not shown) is engaged to the bolt B. Thereby, the body portion 11 is fixed on the shock absorber 110. Here, it is exemplarily described that the body portion 11 is fixed on the shock absorber 110 by using the bolt B and the nut, but other fixing member can be used.

That is, the mounting bracket 10 is fixed on the exterior circumference of the shock absorber 110 by the bolt B and the nut (not shown) that engage the mounting ends 13 to each other through the hole 25.

According to the present exemplary embodiment, the stabilizer link mounting portion 15 is formed by cutting a part of an exterior circumference of the body portion 11 and then bending the part of the exterior circumference of the body portion 11 to be protruded radially outwardly from the body portion 11. The stabilizer link mounting portion 15 is connected to the stabilizer link 119.

Here, the stabilizer link mounting portion 15 includes a hole 17 at a middle portion thereof, and the stabilizer link 119 is mounted at the stabilizer link mounting portion 15 through an engage bolt 19 inserted in the hole 17.

The mounting bracket 10 is preferably formed as one piece by press forming, and the stabilizer link mounting portion 15 is integrally formed with the mounting bracket 10 by bending the part cut from the body portion 11 to be protruded radially outwardly from the body portion 11.

Meanwhile, according to an exemplary embodiment of the present invention, the mounting bracket 10 may further include a reinforcing member 20 for supporting the stabilizer link mounting portion 15.

The reinforcing member 20 includes a bonding portion 21 and a supporting portion 23, and each component will be described in detail.

The bonding portion 21 is mounted in a state of being contacted with one surface of the stabilizer link mounting portion 15 integrally formed with the body portion 11 and includes a hole 31. The bonding portion 21 and the stabilizer link mounting portion 15 may be connected by the engage bolt 19 through the holes 17 and 31.

In addition, the supporting portions 23 are formed by bending both ends of the bonding portion 21 to face each other, are mounted at the exterior circumference of the body portion 11, and support the bonding portion 21.

Here, each supporting portion 23 has an end portion contacted and fixed to the exterior circumference of the body portion 11, and the end portion may be round so as to be closely contacted to the exterior circumference of the body portion 11.

It is preferable that the reinforcing member 20 is welded respectively to the body portion 11 and the stabilizer link mounting portion 15 of the mounting bracket 10.

In an exemplary embodiment of the present invention, the mounting bracket 10 may further include a reinforcing member 27 for supporting the mounting ends 13.

The reinforcing members 27 are mounted on and respectively fixed to one outer surface of the mounting ends 13 integrally formed with the body portion 11.

It is preferable that the reinforcing members 27 may be welded respectively to the body portion 11 and the mounting ends 13. The reinforcing members 27 include a hole 29 and thereby the reinforcing member 27 and the mounting ends 13 may be connected by the bolt B through the holes 25 and 29.

The stabilizer link mounting unit 1 for a shock absorber according to an exemplary embodiment of the present invention is formed as one piece in order to mount the stabilizer link 119 connecting the shock absorber 110 with the stabilizer bar 117, and is removably mounted on the exterior circumference of the shock absorber 110. Therefore, mounting processes of the stabilizer link mounting unit 1 may be facilitated. Since mounting position of the stabilizer link mounting unit 1 can be changed, the stabilizer link mounting unit 1 can be mounted at the shock absorber 110 without interference with other components, and thereby layout DOF of the shock absorber 110 may be improved.

In addition, since the stabilizer link mounting unit 1 according to an exemplary embodiment of the present invention uses the mounting bracket 10 formed as one piece and removably mounted on the shock absorber 110 instead of a conventional link bracket welded on the shock absorber, the stabilizer link mounting unit 1 is not directly welded on the shock absorber 110. Therefore, the shock absorber 110 may not be damaged by heat generated in a welding process, and performance and durability of the shock absorber 110 may be improved.

In addition, since the mounting bracket 10 is formed as one piece according to an exemplary embodiment of the present invention, manufacturing processes of the stabilizer link mounting unit 1 may be simplified. Also, since the stabilizer link mounting portion 15 is formed by cutting the part of the body portion 11 and bending it, weight of the stabilizer link mounting unit 1 may not increase.

According to an exemplary embodiment of the present invention, a stabilizer link mounting unit is formed as one piece in order to mount a stabilizer link connecting a shock absorber with a stabilizer bar, and is removably mounted on an exterior circumference of the shock absorber. Therefore, mounting processes of the stabilizer link mounting unit may be facilitated, the stabilizer link mounting unit can be mounted at the shock absorber without interference with other components, and layout DOF of the shock absorber may be improved.

In addition, since the mounting bracket is mounted on the shock absorber by a bolt and a nut, the shock absorber may be prevented from being heat damaged, and performance and durability of the shock absorber may be improved.

In addition, since the mounting bracket is formed as one piece, manufacturing processes of the mounting bracket may be simplified. Further, since the stabilizer link mounting portion is formed by cutting the part of the body portion and bending it, weight of the stabilizer link mounting unit may not increase.

For convenience in explanation and accurate definition in the appended claims, the terms “upper”, “lower”, and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A stabilizer link mounting unit for a shock absorber for mounting a stabilizer link connected to a stabilizer bar to the shock absorber, comprising a mounting bracket formed as one piece and removably engaged on an exterior circumference of the shock absorber, wherein the mounting bracket is connected to the stabilizer link.

2. The stabilizer link mounting unit of claim 1, wherein the mounting bracket includes:
a body portion bent as a cylindrical shape and removably wrapping the exterior circumference of the shock absorber therein;
mounting ends formed respectively at both ends of the body portion, and releasably fixing the body portion onto the shock absorber by a first fixing member; and
a stabilizer link mounting portion formed by cutting a portion of an exterior circumference of the body portion and bending the portion outwards so as to be protruded radially from the body portion with a predetermined length, and connected to the stabilizer link by a second fixing member.

3. The stabilizer link mounting unit of claim 2, wherein the mounting ends are formed by bending distal end portions of the body portion so as to protrude outwards from the body portion with a predetermined length.

4. The stabilizer link mounting unit of claim 2, wherein the mounting ends are provided with a first hole at a middle portion thereof and fastened by the first fixing member.

5. The stabilizer link mounting unit of claim 4, wherein the fixing member includes a bolt inserted in the first hole.

6. The stabilizer link mounting unit of claim 4, wherein the mounting bracket further includes a first reinforcing member reinforcing the mounting ends.

7. The stabilizer link mounting unit of claim 6, wherein the first reinforcing member is fixed to an external surface of the mounting ends with a predetermined thickness.

8. The stabilizer link mounting unit of claim 7, wherein the first reinforcing member is fixed to an external surface of the body portion.

9. The stabilizer link mounting unit of claim 6, wherein the first reinforcing member is provided with a second hole at a middle portion thereof and the first reinforcing member and the mounting ends are fastened each other by the first fixing member through the first hole and the second hole respectively.

10. The stabilizer link mounting unit of claim 2, wherein the stabilizer link mounting portion is provided with a third hole at a middle portion thereof, and the stabilizer link is mounted to the stabilizer link mounting portion through the third hole by the second fixing member.

11. The stabilizer link mounting unit of claim 10, wherein the second fixing member includes a bolt inserted in the third hole.

12. The stabilizer link mounting unit of claim 10, wherein the mounting bracket further includes a second reinforcing member reinforcing the stabilizer link mounting portion.

13. The stabilizer link mounting unit of claim 12, wherein the second reinforcing member includes:
a bonding portion mounted in a state of being contacted to a surface of the stabilizer link mounting portion and fixed thereto to be integrally formed with the body portion, wherein the bonding portion includes a fourth hole; and
a supporting portion extending from both distal ends of the bending portion to face each other with a predetermined distance therebetween, mounted along an exterior circumference of the body portion, and supporting the bonding portion.

14. The stabilizer link mounting unit of claim 13, wherein each supporting portion has an end portion contacted and fixed to the exterior circumference of the body portion, and the end portion is formed round along the exterior circumference of the body portion.

15. The stabilizer link mounting unit of claim 13, wherein the stabilizer link mounting portion and the bonding portion are mounted to the stabilizer link by the second fixing member through the third hole and the fourth hole respectively.
